(19) United States
(12) Patent Application Publication
(10) Pub. No.: US 2014/0299543 A1
(43) Pub. Date: Oct. 9, 2014

(54) EXTRACTION OF METALS

(71) Applicants: Jingfang Zhou, Mawson Lakes (AU); John Ralston, Mitcham (AU); Craig Ian Priest, Athelstone (AU); Rossen Velizarov Sedev, Modbury North (AU)

(72) Inventors: Jingfang Zhou, Mawson Lakes (AU); John Ralston, Mitcham (AU); Craig Ian Priest, Athelstone (AU); Rossen Velizarov Sedev, Modbury North (AU)

(73) Assignee: University of South Australia, Adelaide (AU)

(21) Appl. No.: 13/994,210

(22) PCT Filed: Dec. 16, 2011
(86) PCT No.: PCT/AU2011/001633

§ 371 Date: Jun. 20, 2014

(30) Foreign Application Priority Data
Dec. 17, 2010 (AU) 2010905533

(51) Int. Cl. B01D 11/04

(52) U.S. Cl. CPC B01D 11/0496
USPC 210/638

(57) ABSTRACT

A process for extracting a target metal ion from an aqueous feedstock containing, inter alia, the target metal ion. The process comprises providing said feedstock and contacting the feedstock with a room temperature ionic liquid (RTIL) that is substantially free of an extraneous organic extractant under liquid-liquid extraction conditions for a time sufficient to allow transfer of at least some of the target metal ions from the feedstock to the RTIL. The RTIL is then separated from the feedstock and the target metal ions are recovered from the RTIL.

This patent application claims priority from Australian Provisional Patent Application No. 2010905533 titled “Extraction of Metals” and filed 17 Dec. 2010, the entire contents of which are hereby incorporated by reference.

### FIELD

The present invention relates to processes for extracting target metal ions from aqueous solutions using liquid-liquid extraction.

### BACKGROUND

Liquid-liquid extraction, also known as solvent extraction (SX), is a process for separating a specific component from a mixture that is widely used in manufacturing, synthetic chemistry, analytical chemistry, waste treatment, and nuclear waste processing (Bernardis, Grant et al. 2005). In mineral processing, SX plays an important role in recovery and refining of valuable metals from mineral ores including copper, precious metals, uranium and lanthanides, etc (Billard, Ouadi et al.; Kumar, Sahu et al. 2010).

SX offers a number of advantages of other separation processes, such as continuous operation, simple equipment, high throughput, as well as diversity of the extraction chemistry. Thus, SX is a separation technique of major industrial significance (Bond, Dietz et al. 1999; Gmehling 2004). In traditional SX, the two immiscible phases are an organic solvent and an aqueous solution. However, many common organic solvents are volatile, flammable and toxic, and therefore are hazardous and are becoming less acceptable from an environmental viewpoint. Disposal of spent extractants and diluents also attracts increasing costs through the impact of environmental protection regulations.

In recent times, room temperature ionic liquids (RTILs) have gained interest in solvent extraction processes as they are potentially environmentally benign alternatives to the use of volatile organic compounds (VOCs). RTILs possess a number of potential advantages over traditional VOCs, such as a wide liquid range of up to 200° C., good thermal stability up to 300° C., extremely low vapour pressure, non-flammability and the properties of the RTILs can be fine-tuned by varying the anion and cation. RTILs are known to be polar but non-coordinating media, and have been shown to dissolve different organic, inorganic, organometallic and biomolecules. For example, RTILs have been used as a liquid-liquid extraction media to separate organic solutes, such as aromatic solutes, from aqueous solutions (Huddleston, Wilauer et al. 1998; Gmehlig, 2004).

To date, a limited range of RTILs have been used in solvent extraction processes to extract metal ions from aqueous solutions. Dai et al. (1999) describes a process for extracting strontium from aqueous solutions of strontium nitrate using an RTIL containing a crown ether. Dietz et al. (2006) describes processes for extracting various metal ions using ionic liquids containing organic extractants such as 1-(2-pyridylazo)-2-naphthol (PAN), 1-(2-thiazolyl)-2-naphthol (TAN), crown ethers and calixarenes. Visser and Rogers (2003) describe processes for extracting actinide metals from aqueous solutions using RTILs containing crown ethers. In each of the aforementioned processes, the RTILs are used as a solvent and an organic extractant is added to the organic phase. In the absence of an extractant, the distribution ratios in [C₄mim][PF₆]/aqueous phases at pH 1 to 13 of the metal ions studied (including Hg²⁺, Cd²⁺, Co²⁺, Ni²⁺, Fe³⁺) were all relatively low, indicating retention in the aqueous phase. In the presence of extractants, the partitioning of the extracted organic moieties or metal ions in the RTIL/water systems is similar to the partitioning that is achieved in traditional organic solvent-water systems.

A problem with the use of RTILs on a large scale is the cost of the solvent and the higher viscosity of the RTILs relative to VOCs. This is further compounded by the fact that extractants need to be added to the RTILs to assist in the efficient extraction of metals from aqueous solutions.

There is a need for a better understanding of the kinetics of extraction of metal ions from aqueous solutions using RTILs and also any relationship between the structure of the RTIL (the cation and/or the anion) and the extraction efficiency. Alternatively and/or in addition, there is a need for improved extraction processes using RTILs.

### SUMMARY

The present invention arises from research into the extraction of precious metals and base metals from aqueous phases into different types of RTILs, and in particular, our finding that RTILs can be used in liquid-liquid extraction of metal ions not only as solvents but also extractants. We have shown that RTILs can be used as effective anion exchange extractants and that the extraction process is fast and highly efficient with extraordinarily high loading capacity. For example, some metals can be extracted quantitatively in one cycle.

In a first aspect, the present invention provides a process for extracting a target metal ion from an aqueous feedstock containing the target metal ion, the process comprising:
providing said feedstock;
contacting the feedstock with a room temperature ionic liquid (RTIL) under liquid-liquid extraction conditions for a time sufficient to allow transfer of at least some of the target metal ions from the feedstock to the RTIL; and
separating the RTIL from the feedstock,

wherein the RTIL is substantially free of an extraneous organic extractant.

In some embodiments, the target metal ion is chosen from one or more of the group consisting of: Pt, Pd, Fe, Co, Cu, Sn, Bi, Zn, and Mn.

In some embodiments, the process further comprises recovering the target metal ions or metal from the RTIL.

In some embodiments, the process further comprises treating the aqueous feedstock to increase the concentration of inorganic anions in the feedstock prior to contact with the RTIL. In some embodiments, the inorganic anion is selected from the group consisting of: halide ion, thiocyanate ion, thiosulfate ion, nitrate ion, and perchlorate ion. In some embodiments, the halide ion is selected from iodide, bromide, chloride, and fluoride. In some specific embodiments, the halide ion is chloride.

In some embodiments, the RTIL is selected from the group consisting of: ethyl-3-methylimidazolium bis(trifluoromethanesulfonypimide (emim.NTf₂); 1-hexyl-3-methylimidazolium bis(trifluoromethanesulfonypimide (hmim.NTf₂); 1-hexyl-3-methylimidazolium hexafluorophosphate (hmim.PF₆); 1-dodecyl-3-methylimidazoliumbis(trifluoromethylsulfonypimide (dmim.NTf₂); 1-methyl-1-propylpiperidinium bis(trifluoromethylsulfonypimide (mppip.NTf₂); 1-methyl-1-propylpyrrolidinium bis(trifluoromethylsulfonyl)imide (mpPyr.NTf₂); tradecyl(trihexyl)phosphonium bis(trifluoromethanesulfonyl)imide P_{14,6,6,6}.NTf₂); tetradecyl(trihexyl)phosphonium chloride (P_{14,6,6,6}. Cl); methyltrioctylammonium bis(trifluoromethylsulfonyl)imide (N_{8,8,8,1}.NTf₂); and butyltrimethylammonium bis(trifluoromethylsulfonyl)imide (N_{4,1,1,1}.NTf₂).

In some specific embodiments, the RTIL is tetradecyl(trihexyl)phosphonium chloride (P_{14,6,6,6}.Cl). In these embodiments, the target metal ion may be selected from the group consisting of: Pt, Pd, Cu, Fe, Co, Mn, Zn, Bi, and Sn ions.

In some specific embodiments, the RTIL is 1-hexyl-3-methylimidazolium bis(trifluoromethanesulfonyl)imide (hmim.NTf₂). In these embodiments, the target metal ion may be selected from the group consisting of: Pt, Bi, and Sn ions.

In some specific embodiments, the RTIL is 1-dodecyl-3-methylimidazolium bis(trifluoromethanesulfonyl)imide (dmim.NTf₂). In these embodiments, the target metal ion may be Pt ions.

In some specific embodiments, the RTIL is methyltrioctylammonium bis(trifluoromethylsulfonyl)imide (N_{8,8,8,1}.NTf₂). In these embodiments, the target metal ions may be selected from the group consisting of: Pt, Pd, Bi, and Sn ions.

In some specific embodiments, the RTIL is 1-hexyl-3-methylimidazolium hexafluorophosphate (hmim.PF₆). In these embodiments, the target metal ion may be selected from the group consisting of: Pt and Pd ions.

Surprisingly, we have found that Sn, Bi, Cu, Zn, Mn, Fe and/or Co ions can be selectively extracted from an aqueous feedstock that also contains Mg, Ca, Al, Cr, and/or Ni ions at 3M HCl concentration using tetradecyl(trihexyl)phosphonium chloride as the RTIL.

We have also found that Sn, Bi, and/or Fe ions can be selectively extracted from an aqueous feedstock containing Mg, Ca, Al, Cu, Zn, Cr, Mn, Co, and/or Ni ions at 3M HCl concentration using 1-hexyl-3-methylimidazolium hexafluorophosphate as the RTIL.

We have further found that Sn, Bi, and/or Fe ions can be selectively extracted from aqueous feedstock containing Mg, Ca, Al, Cu, Zn, Cr, Mn, Co, and/or Ni ions at 3M HCl concentration using methyltrioctylammonium bis(trifluoromethylsulfonyl)imide as the RTIL.

### BRIEF DESCRIPTION OF THE ACCOMPANYING FIGURES

FIG. 1 shows a plot of extraction percentage of Pt versus various RTILs at different HCl concentrations.

FIG. 2 shows a plot of extraction percentage of Pd versus various RTILs at different HCl concentrations.

FIG. 3 shows a plot showing a comparison of extraction percentage of Pt and Pd versus various RTILs at different 3M HCl concentration.

FIG. 4 shows a plot of extraction percentage of Cu versus various RTILs at different HCl concentrations.

FIG. 5 shows a plot of extraction percentage of Fe, Co and Cu by P_{14,6,6,6}.Cl at different HCl concentrations and 3M KCl concentration.

FIG. 6 shows a plot of the logarithm of distribution reaction of Fe, Co and Cu extracted by P_{14,6,6,6}.Cl at different HCl concentrations.

FIG. 7 shows a plot of extraction percentage of different metals extracted by hmim.NTf₂, N_{8,8,8,1}.NTf₂ and P_{14,6,6,6}.Cl at 3M HCl concentration.

FIG. 8 (a) shows a schematic of the solvent extraction using microfluidic streams of aqueous and organic phase; (b) shows an image of the microchip in operation; (c) shows an image of the UV-vis flow cell (Fiber Optic SMA Z-Flow Cell) which was coupled to the outlet of the solvent extraction chip for online analysis of the extraction performance. The direction of flow is shown by the arrows. Optic fibres were connected to the light source and spectrometer (not shown), and fitted to the cell (left and right).

FIG. 9 shows a plot of extraction percentage of Au, Pt and Pd from their mixture versus RTILs at 0.02 M HCl concentration

FIG. 10 shows a plot of extraction percentage of Au, Pt and Pd from their mixture versus RTILs at 0.1 M HCl concentration

FIG. 11 shows a plot of extraction percentage of Au, Pt and Pd from their mixture versus RTILs at 2 M HCl concentration

FIG. 12 shows a plot of extraction percentage of Au, Pt and Pd from their mixture at 0.1 M HCl solution in a microchannel as a function of residence time

### DETAILED DESCRIPTION

The present invention provides a process for extracting a target metal ion from an aqueous feedstock containing the target metal ion. The process Comprises providing said feedstock. The feedstock may be any aqueous solution, suspension, emulsion, etc containing the target metal ion. Examples of feedstocks include leachates, leach solutions, waste water, nuclear waste, reaction mixtures, etc.

The feedstock is contacted with a room temperature ionic liquid (RTIL) under liquid-liquid extraction conditions for a time sufficient to allow transfer of at least some of the target metal from the feedstock to the RTIL. As used herein, the terms “room temperature ionic liquid”, “RTIL”, and similar terms, mean a salt that is in the liquid state at room temperature. Room temperature ionic liquids consist of a bulky, asymmetric organic cation and a smaller anion and they are liquids at relatively low temperatures (eg below about 100° C.). A range of RTILs are available commercially or can be synthesised using known methods. Specific RTILs that are suitable for use in processes of the present invention have imidazolium, piperidinium, pyrrolidiunium, ammonium or phosphonium cations. The anion of the RTIL may be bis(trifluoromethanesulfonyl)imide, chloride or hexafluorophosphate.

In some embodiments, the RUC, is selected from the group consisting of: ethyl-3-methylimidazolium bis(trifluoromethanesulfonyl)imide (emim.NTf₂); 1-hexyl-3-methylimidazolium bis(trifluoromethanesulfonyl)imide (hmim.NTf₂); 1-hexyl-3-methylimidazolium hexafluorophosphate (hmim.PF₆); 1-dodecyl-3-methylimidazoliumbis(trifluoromethylsulfonyl)imide (dmim.NTf₂); 1-methyl-1-propylpiperidinhun bis(trifluoromethylsulfonyl)imide (mppip.NTf₂); 1-methyl-1-propylpyrrolidinium bis(trifluoromethylsulfonyl)imide (mpPyr.NTf₂); tradecyl(trihexyl)phosphonium bis(trifluoromethanesulfonyl)imide P_{14,6,6,6}.NTf₂); tetradecyl(trihexyl)phosphonium chloride (P_{14,6,6,6}.Cl); methyltrioctylammonium bis(trifluoromethylsulfonyl)imide (N_{8,8,8,1}.NTf₂); and butyltrimethylammonium bis(trifluoromethylsulfonyl)imide (N_{4,1,1,1}.NTf₂).

Specific RTILs that we have found to be particularly suitable for use in the processes of the present invention include tetradecyl(trihexyl)phosphonium chloride (P_{14,6,6,6}.Cl), 1-hexyl-3-methylimidazolium bis(trifluoromethanesulfonyl)imide (hmim.NTf₂), 1-dodecyl-3-methylimidazolium bis(trifluoromethanesulfonyl)imide (dmim.NTf₂), methyltrioctylammonium bis(trifluoromethylsulfonypimide (N_{8,8,8,1}.NTf₂), and 1-hexyl-3-methylimidazolium hexafluorophosphate (hmim.PF₆).

The RTIL may be a pure or semi-pure RTIL or it could be part of a mixture containing, for example, another water immiscible solvent. The RTIL is substantially free of an extraneous organic extractant, the significance, of which will be described in more detail later.

The feedstock can be contacted with the RTIL using any apparatus or technique suitable for liquid-liquid extraction. For example, the feedstock may be contacted with the RTIL by combining the two phases in a suitable vessel and mixing to at least partially disperse the phases in one another. The time taken for mixing will vary depending on the nature of the ion to be extracted, the feedstock, the particular RTIL used, the temperature, etc. Processes for bulk phase solvent extraction are known in the art.

Alternatively, the feedstock and the RTIL may be mixed in a microfluidic liquid-liquid extraction device. The microfluidic liquid-liquid extraction device may be as described herein and/or as described in our co-pending published application WO 2010/022441 titled “Extraction Processes” (the disclosure of which is incorporated herein in its entirety) and/or our co-pending unpublished Australian provisional patent application 2010905349 titled “High Throughput Microfluidic Device” and/or using any of the microfluidic separation techniques known in the art. Briefly, the microfluidic device may comprise a microchip containing an aqueous phase microchannel and an extractant phase microchannel. A pressure driven, co-current laminar flow technique may be applied during the process of solvent extraction in the microchannel, where the aqueous phase and the extractant phase converge at a Y-junction and flow together without mixing along the channel length, before separating at another Y-junction downstream. The residence time for extraction can be manipulated by altering the flow rate of the two phases using syringe pumps.

After the feedstock and the RTIL have been in contact with one another for a time sufficient to allow transfer of at least some of the target metal ion from the feedstock to the RTIL, the RTIL is separated from the feedstock. In most cases, the two phases are physically separated from one another using any of the techniques known for that purpose in the art. For example, in a bulk extraction vessel, the aqueous feedstock may be removed from the bottom of the vessel using a suitable valve located toward the bottom of the vessel.

After separating the RTIL from the feedstock, the target metal ion can be recovered from the RTIL either as ions or as the metal. Methods for recovering metal ions or metals from solvents or solution are known in the art and can be used in the processes of the present invention. For example, the RTILs can be used as electrolytes and, therefore, many of the metals extracted into RTILs, including Pd, Pt, Sn, Bi, Cu and Zn, can be recovered by electro-deposition from the RTILs. The stripping stage that is typically used in conventional solvent extraction is therefore not needed in the processes of the present invention. By way of further example, the RTIL containing the target metal ion can be treated with a reducing agent to reduce metal ions to metals which are then able to be separated from the RTIL.

It will be appreciated from the foregoing description that in the processes of the present invention the RTIL is substantially free of any extraneous organic extractant. This is in contrast to prior art processes described previously which use an organic extractant in the RTIL.

The process may further comprise treating the aqueous feedstock to increase the concentration of inorganic anions in the feedstock prior to contact with the RTIL. In some embodiments, the “inorganic anion” is selected from the group consisting of: halide ion, thiocyanate ion, thiosulfate ion, nitrate ion, and perchlorate ion. In some embodiments, the halide ion is selected from iodide, bromide, chloride, and fluoride. In some specific embodiments, the halide ion is chloride.

The concentration of inorganic anions in the aqueous feedstock can be increased by adding a salt containing the inorganic anion to the feedstock. For example, the concentration of halide ion in the aqueous feedstock can be increased by adding a halide salt to the feedstock. In the case of chloride, suitable halide salts include HCl, KCl, NaCl, NH₄Cl, etc. Equivalent iodide, bromide, fluoride, thicyanate, nitrate or perchlorate salts could be used.

In some specific embodiments, the process comprises treating the aqueous feedstock with HCl to increase the chloride concentration in the feedstock prior to contact with the RTIL. The amount of HCl added to the feedstock may depend on the target metal and/or the RTIL used. In some embodiments, the aqueous feedstock is from about 0.01M to about 10M HCl. In some specific embodiments, the aqueous feedstock is from about 0.01M to about 0.090M HCl. In some other specific embodiments, the aqueous feedstock is from about 1M to about 9M HCl. In some other specific embodiments, the aqueous feedstock is from about 2M to about 4M HCl. In some other specific embodiments, the aqueous feedstock is from about 6M to about 9M HCl. In some other specific embodiments, the aqueous feedstock is about 0.02M HCl. In some other specific embodiments, the aqueous feedstock is about 3M HCl. In some other specific embodiments, the aqueous feedstock is about 7M HCl.

In some specific embodiments, the process comprises treating the aqueous feedstock with KCl to increase the chloride concentration in the feedstock prior to contact with the RTIL. The amount of KCl added to the feedstock may depend on the target metal and/or the RTIL used. In some embodiments, the aqueous feedstock is from about 1M to about 9M HCl. In some specific embodiments, the aqueous feedstock is about 3M KCl.

In some embodiments, the process also comprises treating the aqueous feedstock to decrease the pH of the feedstock prior to contact with the RTIL.

The target metal ion may be chosen from one or more of the group consisting of: Pt, Pd, Fe, Co, Cu, Sn, Bi, Zn, and Mn. We have found that certain RTILs show selectivity for some of these metal ions over other metal ions. This means that the processes described herein may be used to selectively extract a target metal ion from an aqueous feedstock solution containing other non-target metal ions.

In some embodiments, the RTIL is tetradecyl(trihexyl)phosphonium chloride (P_{14,6,6,6}.Cl). In these embodiments, the target metal may be selected from the group consisting of: Pt, Pd, Cu, Fe, Co, Mn, Zn, Bi, and Sn.

In some embodiments, the RTIL is 1-hexyl-3-methylimidazolium bis(trifluoromethanesulfonyl)imide (hmim.NTf₂). In these embodiments, the target metal may be selected from the group consisting of: Pt, Bi, and Sn.

In some embodiments, the RTIL is 1-dodecyl-3-methylimidazolium bis(trifluoromethanesulfonyl)imide (dmim.NTf₂). In these embodiments, the target metal may be Pt.

In some embodiments, the RTIL is methyltrioctylammonium bis(trifluoromethylsulfonyl)imide (N_{8,8,8,1}.NTf₂). In these embodiments, the target metal may be selected from the group consisting of: Pt, Pd, Bi, and Sn.

In some embodiments, the RTIL is 1-hexyl-3-methylimidazolium hexafluorophosphate (unim.PF₆). In these embodiments, the target metal may be selected from the group consisting of: Pt and Pd.

Surprisingly, we have found that Sn, Bi, Cu, Zn, Mn, Fe and/or Co ions can be selectively extracted from aqueous feedstock that also contains Mg, Ca, Al, Cr, and/or Ni ions at 3M HCl concentration using tetradecyl(trihexyl)phosphonium chloride as the RTIL.

We have also found that Sn, Bi, and/or Fe ions can be selectively extracted from aqueous feedstock containing Mg, Ca, Al, Cu, Zn, Cr, Mn, Co, and/or Ni ions at 3M HCl concentration using 1-hexyl-3-methylimidazolium hexafluorophosphate as the RTIL.

We have further found that Sn, Bi, and/or Fe ions can be selectively extracted from aqueous feedstock containing Mg, Ca, Al, Cu, Zn, Cr, Mn, Co, and/or Ni ions at 3M HCl concentration using methyltrioctylammonium bis(trifluoromethylsulfonyl)imide as the RTIL.

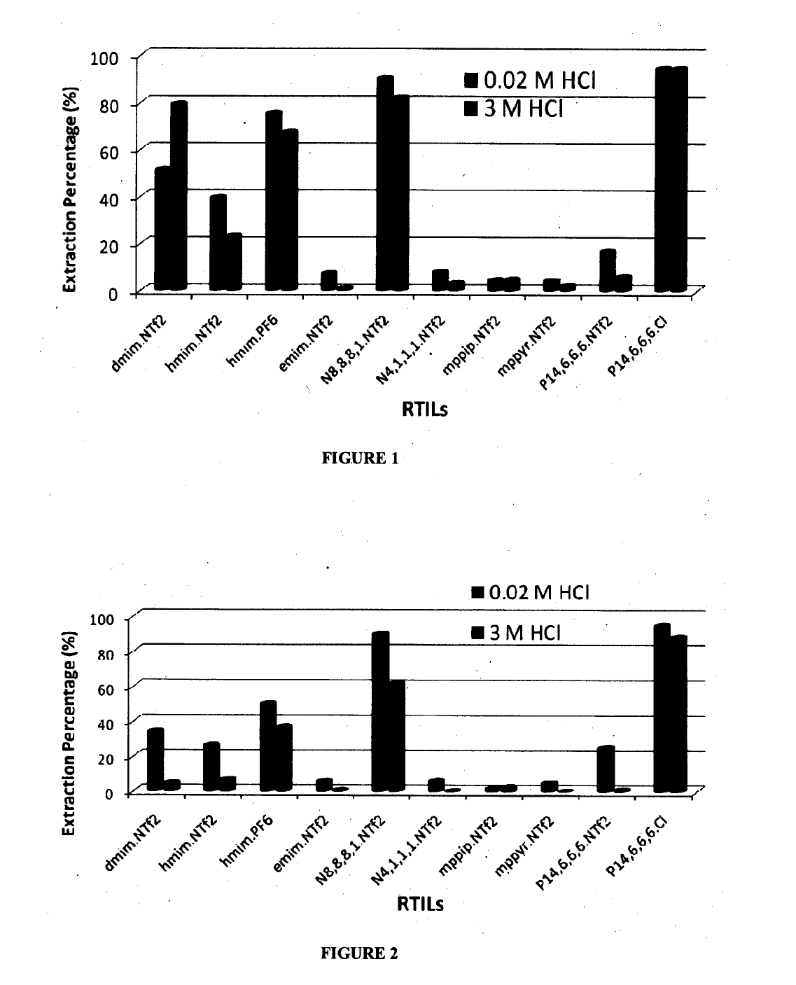

The performance of specific ionic liquids on the extraction of Pt and Pd from 0.02 and 3 M HCl solutions is shown in FIGS. 1 and 2, respectively. The results show that Pt can be extracted effectively by P_{14,6,6,6}.Cl, N_{8,8,8,1}.NTf₂, hmim.PF₆ and dmim.NTf₂. Pd can be extracted by P_{14,6,6,6}.Cl, N_{8,8,8,1}.NTf₂ and hmim.PF₆. With an increase in HCl concentration, the extraction percentage decreases except for Pt extracted with dmim.NTf₂. Longer hydrocarbon chains in the cation of the RTIL give rise to a higher extraction percentage. With chains shorter than six carbon atoms in the normal chain, low extraction percentages were found. N_{8,8,8,1}.NTf₂ can extract Pt and Pd better than hmim.PF₆. The efficiency of RTILs decreases in the following order: P_{14,6,6,6}.Cl>N_{8,8,8,1}.NTf₂>hmim.PF₆>other RTILs.

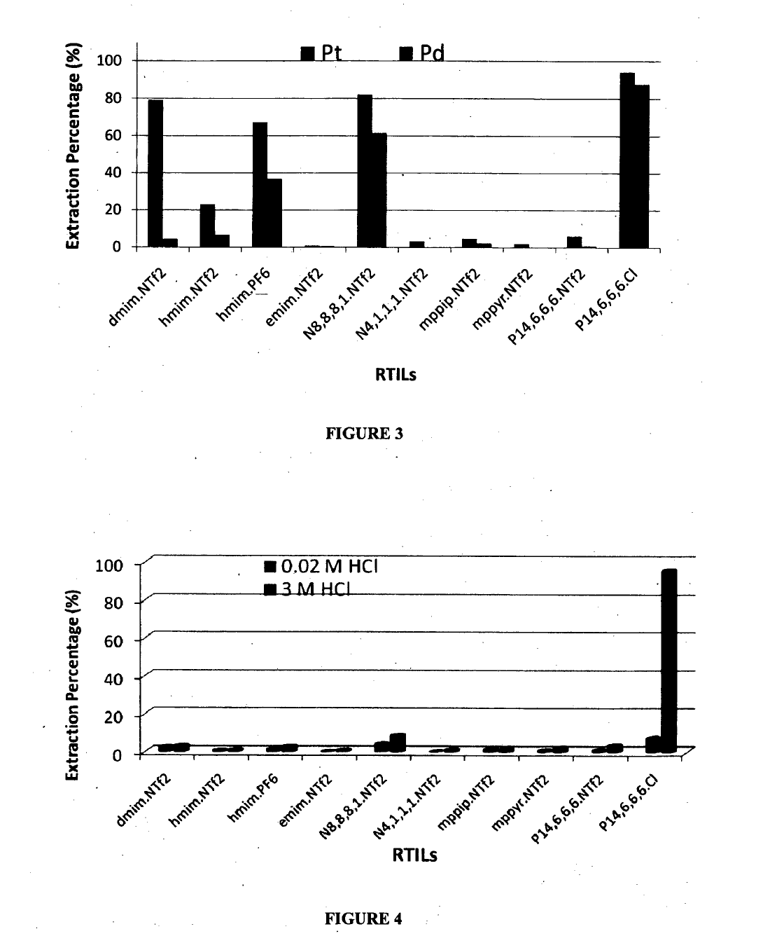

FIG. 3 shows the comparison of extraction percentage of Pt and Pd versus different RTILs at 3 M HCl concentration. It shows that the extraction percentage decreases in the order of Pt>Pd. RTILs including P_{14,6,6,6}.Cl, N_{8,8,8,1}.NTf₂, hmim.PF₆, dmim.NTf₂ and hmim.NTf₂ can extract both of these metals to a certain extent. Among them, P_{14,6,6,6}.Cl can extract Pt and Pd well above 85% for each metal.

The invention is hereinafter described by way of the following non-limiting examples.

### EXAMPLES

### Example 1

### Bulk Solution Phase Extraction of Various Metals Using RTILs

### RTILS

All RTILs used in this investigation (listed below) were purchased from IoLiTec, Germany, except for tetradecyl(trihexyl)phosphonium bis(trifluoromethanesulfonyl)imide, which was purchased from Strem Chemicals, USA. Five types of cations were studied: imidazolium (Im), piperidinium (Pip), pyrrolidinium (Pyr), ammonium (N) and phosphonium (P). In all cases the anion was bis(trifluoromethanesulfonyl) imide (NTf₂). The anions hexafluorophosphate (PF₆) and chloride (Cl) were further chosen for hmim and phosphonium cations, respectively. Imidazolium and ammonium cations with different chain lengths were also used.
Ethyl-3-methylimidazolium bis(trifluoromethanesulfonyl)imide, 98%, (emim.NTf₂)
1-Hexyl-3-methylimidazolium bis(trifluoromethanesulfonyl)imide, 98%, (hmim.NTf₂)
1-Hexyl-3-methylimidazolium hexafluorophosphate, 99%, (hmim.PF₆)
1-Dodecyl-3-methylimidazoliumbis(trifluoromethylsulfonypimide, 98%, (dmim.NTf₂)
1-Methyl-1-propylpiperidinium bis(trifluoromethylsulfonyl)imide, 99%, (mppip.NTf₂)
1-Methyl-1-propylpyrrolidinium bis(trifluoromethylsulfonyl)imide, 99%: mpPyr.NTf₂
Tetradecyl(trihexyl)phosphonium bis(trifluoromethanesulfonyl)imide, 97%, (P_{14,6,6,6}.NTf₂)
Tetradecyl(trihexyl)phosphonium chloride, 96%, (P_{14,6,6,6}.Cl)
Methyltrioctylammonium bis(trifluoromethylsulfonyl)imide, 99%, (N_{8,8,8,1}.NTf₂)
Butyltrimethylammonium bis(trifluoromethylsulfonyl)imide, 99%, (N_{4,1,1,1}.NTF₂)

### Metal Salts

Fifteen metals were tested. Precious metal salts of AR grade, PdCl₂, and H₂PtCl₆.×H₂O, were purchased from Sigma-Aldrich. AR grade CuCl₂.2H₂O, MgCl₂.6H₂O, AlCl₃.6H₂O and CaCl₂ were purchased from Chem-Supply. AR grade BiOCl, SnCl₂.2H₂O, MnCl₂.4H₂O, FeCl₃.NiSO₄.×H₂O and CrCl₃.6H₂O were obtained from BDH. AR grade CoCl₂.6H₂O was purchased from Merck.

### Stock Solution for Each Metal

All metal salts were dissolved in pure water with different HCl concentrations (typically 0.02, 3 and 7 M HCl). Stock solutions of the precious metals were prepared: 500 ppm PdCl₂ and 1000 ppm H₂PtCl₆. The concentrations of copper and nickel were 5 and 15 g/L, respectively. For all other metals, the concentration of metal salt was 10 g/L.

### Conventional Batch Solvent Extraction

0.5 ml RTIL and 2 ml aqueous solution containing metal ions were added into a small glass vial. They were mixed vigorously with a magnetic stirrer for 30 min to achieve equilibrium distribution. When extraction was completed, the solution was left overnight to phase separate. After that, the aqueous phase was carefully removed and used for UV or ICP measurement.

### the Influence of Hydrophobic SiO₂ Nanoparticles on Copper Extraction

SiO₂ nanoparticles (R816) were purchased from Degussa. The primary particle size is 12 nm and the water contact angle is 30-40°. 5 g/L of copper solution was prepared in 0.02 and 3 M HCl, as well as in 3 M KCl solution. SiO₂ nanoparticles (5 g/L) were then added, in the above solution and sonicated for 30 min before extraction. The copper solution loaded with SiO₂ nanoparticles was extracted with P_{14,6,6,6}.Cl under the same conditions as described above.

### Extraction Percentage

Extraction percentage is defined as the amount of solute in the ionic liquid phase (after extraction) divided by the amount in aqueous phase (before extraction). UV-vis and ICP techniques were used to determine the concentration of metal ions in the aqueous solutions before and after extraction. For precious metals and Cu, Ni, Fe, and Co, the UV-vis absorption spectra in the aqueous phase were recorded. The absorbance at a given wavelength (HAuCl₄ at 310 nm, PdCl₂ at 429 nm, H₂PtCl₆ at 375 nm CuCl₂ at 807 nm NiCl₂ at 393 nm, FeCl₂ at 337 nm and CoCl₂ at 510 nm) was used to calculate the extraction percentage as:

E %=[(A₀−A*)/A₀]×100
A₀: absorbance before extraction, A*: absorbance after extraction.

For all other metals, the ICP technique was used to measure the concentration of metal ions in aqueous solution after extraction. The extraction percentage was calculated as:

E %=[(C₀−C*)/C₀]×100
C₀: concentration before extraction, C*: concentration after extraction.

### Distribution Ratio

The distribution ratio is defined as the concentration of the solute in the ionic liquid divided by its concentration in the aqueous phase:

D=[M]_{IL}/[M]_{aq}

The relationship between extraction percentage and distribution ratio is:

E=100D/[D+(V_{aq}/V_{IL})]

In our study, the volume ratio of ionic liquid and aqueous phase is not equal to 1. The distribution ratio is therefore calculated as:

D=[(C₀−C*)/C₀]×V_{aq}/V_{IL}
C₀: concentration before extraction, C*: concentration after extraction. V_{aq} is the volume of the aqueous phase (2 ml). V_{IL} is the volume of the ionic liquid. The weight of the ionic liquids was measured and the volume was calculated using the known density.

RTILs can also be used to extract base metals. Cu extraction was carried out under the same conditions as those used for the precious metals. The results for Cu extraction with different RTILs from 0.02 M and 3 M HCl solutions are shown in FIG. 4. With P_{14,6,6,6}.Cl over 90% of the Cu can be extracted from a 3 M HCl solution. All other RTILs were inefficient in extracting Cu from both 0.02 and 3 M HCl solutions. With the increase of HCl concentration in the copper solution, the extraction percentage increased slightly for all RTILs except for P_{14,6,6,6}.Cl at 3 M HCl, which enhanced Cu extraction dramatically. The increase of chain length can enhance the Cu extraction as observed for precious metals. For copper extraction, only the Cl anion performed well no matter what type and structure the cation RTILs have.

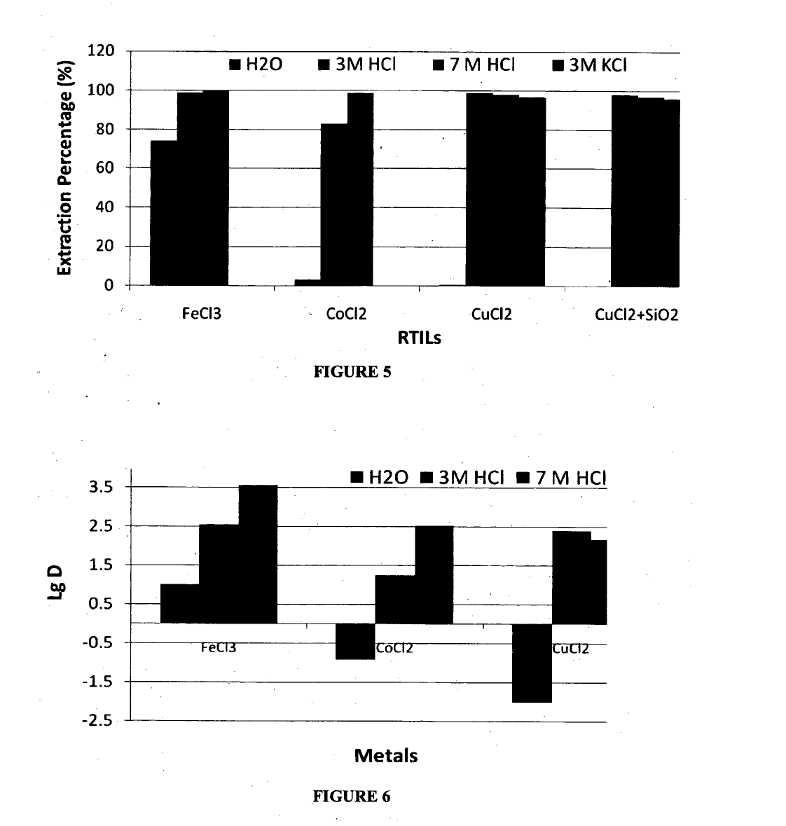

In order to understand the extraction mechanism of base metals, the extraction of Fe, Co and Cu using P_{14,6,6,6}.Cl was conducted under different conditions. The extraction results along with the corresponding distribution ratios are shown in FIGS. 5 and 6.

Iron can be extracted (E ˜70%) even from neutral water. The extraction percentage reached nearly 100% in 3 and 7 M HCl solutions (the distribution ratio was above 3000 in 7 M HCl). Cobalt is not extracted efficiently from neutral water. With increasing HCl concentration, the extraction percentage increases significantly. For copper, no extraction was observed from neutral water. This indicates that, for example, Fe can be selectively extracted from an aqueous feedstock containing Fe, Co and/or Cu ions at neutral pH. However, the extraction percentage of Cu increased dramatically in 3 and 7 M HCl solution. The extraction percentage in 3 M KCl solution was comparable to that in 3 M HCl. Under these conditions, added SiO₂ nanoparticles did not have a significant influence on the extraction percentage. When compared with SiO₂ loaded-organic solvent/aqueous system where particle-stabilized emulsions are formed, RTIL/aqueous system did not show the same phenomena. As the aqueous phase was clear and no apparent UV absorption was observed, SiO₂ particles were likely transferred to the RTILs (which were opaque, though clear when free of SiO₂ particles).

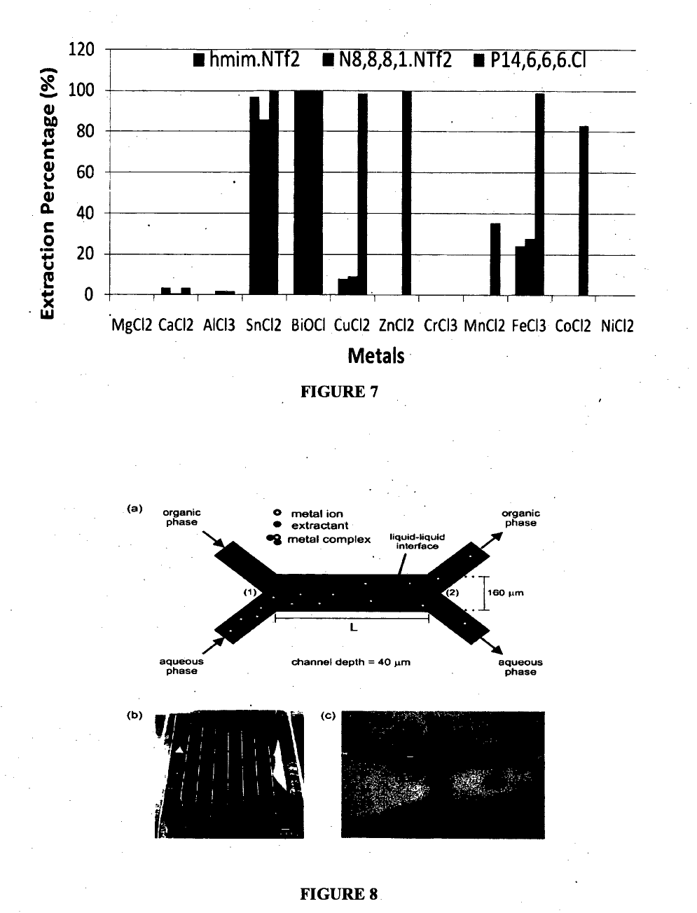

The phenomena observed showed that it is possible to extract base metals effectively when using RTILs including hmim.PF₆, N_{8,8,8,1}.NTf₂ and P_{14,6,6,6}.Cl under high chloride concentrations. Based on these observations, the extraction of other metals, including Mg, Ca, Al, Sn, Bi, Zn, Cr, Mn and Ni, from 3 M HCl was carried out. The results are shown in FIG. 7. For group A metals, no appreciable Mg can be extracted, while Ca and Al can be extracted to a low extent. However, Sn can be extracted efficiently and Bi can be extracted quantitatively by the three RTILs. With the order of group A metals moving from IIA to VA, extraction efficiency increased dramatically. As for group B metals, Cr and Ni was not extracted by the three RTILs. Zn, Co and Mn can be extracted only by phCl with the extraction percentage above 99%, 80% and less than 40%, respectively. Hmim.NTf2 and mta.NTf2 can extract Cu to a low extent and Fe less than 30%. However, they can be extracted above 98% by phCl. When the order of group B metals moved from IB to IIVB, extraction efficiency decreased significantly. As for group IIIVB metals, the extraction percentage decreased in the order of Fe>Co>>Ni≅0.

It was observed that phase separation can be completed in one to two minutes in most cases. Phase separation time increased with an increase of hydrocarbon chain length. It can take several hours for RTILs with longer chain lengths (≧12 CH₂ units) at low HCl concentrations to complete phase separation. However, it was improved dramatically at high HCl or salt concentrations, where phase separation took only a few minutes.

Anion exchange extraction is a process where metal complex anions move from an aqueous phase to an organic phase, while anions in the organic phase transfer from the organic phase to the aqueous phase. Metal complex anions are surrounded by water molecules and interact with cations in the aqueous phase. When they leave the aqueous phase, they absorb the hydration energy, ΔE_{hy}, as well as the ion association energy, ΔE_{as-w}, releasing cavitation energy in the aqueous phase, −ΔE_{w-w}. During transfer, they absorb cavitation energy, ΔE₀₋₀, to enter into organic phase, meanwhile releasing solvation energy with organic molecules, −ΔEₛₒₗ, as well as ion association energy with cations in organic phase, −ΔEₐₛ₋ₒ. Ignoring any entropy change, the free energy change during transfer of metal complex anions can be described by equation 1 (Al-bazi and Chow 1984; Zhang 1984; Yu 2004):

ΔE_{A-W}=(ΔE_{hy}−ΔEₛₒₗ)_{A-W}+ΔE_{w-w}+ΔE₀₋₀)_{A-W}−(ΔE_{as-w}−ΔEₐₛ₋ₒ)_{A-W} (1)

Three types of energy are thus involved during this process, which are solvation energy, cavitation energy and ion association energy. Solvation or Hydration energy is proportional to the charge density of ions, while cavitation energy is inversely proportional to charge density. Ion association energy can be expressed by the ion-pair formation constant, which follows Bjerrum's equation for purely Coulombic attraction (Morrison and Freiser 1957):

$$K = \frac{4 π N}{1000} \frac{{e}^{2}}{ɛ κ T} Q ( b )$$

$$b = \frac{{e}^{2}}{a ɛ κ T}$$

where N is Avogadro's number, e is the unit of charge, E is the dielectric constant of the medium, k is the Boltzmann constant, T is the absolute temperature,

$$Q \frac{{e}^{2}}{( a ɛκ T )}$$

is a calculable function, and α is an empirical parameter which represents the distance between charge centres of the paired ions when in contact. If the temperature is constant, it is evident that ion association depends on the values of α and ∈, decreasing with increasing α and ∈ values. However, if specific interactions between the paired ions occur, greatly increased stability would result. In most cases, it is expected that ΔE_{hy}>>ΔEₛₒₗ, ΔE_{w-w}>>ΔE₀₋₀ and ΔE_{as-w}<<ΔEₐₛ₋ₒ, therefore, ΔE_{MA} can be simply described by equation 2:

ΔE_{A-W}=(ΔE_{hy})_{A-W}−(ΔE_{w-w})_{A-W}−(ΔEₐₛ₋ₒ)_{A-W} (2)

When anions in the organic phase transfer to the aqueous phase, the free energy change follows the equation 3:

ΔE_{A-O}=−(ΔE_{hy})_{A-O}+(ΔE_{w-w})_{A-O}+(ΔEₐₛ₋ₒ)_{A-O} (3)

Therefore, the total free energy change of anion exchange extraction follows the equation 4(Al-bazi and Chow 1984; Mooiman 1993; Yu 2004):

$$\begin{matrix}Δ E = Δ {E}_{A - W} + Δ {E}_{A - O} \\ = [ {( Δ {E}_{hy} )}_{A - W} - {( Δ {E}_{hy} )}_{A - O} ] + [ {( Δ {E}_{w - w} )}_{A - O} - {( Δ {E}_{w - w} )}_{A - W} ] + \\ [ {( Δ {E}_{as - o} )}_{A - O} - {( Δ {E}_{as - o} )}_{A - W} ]\end{matrix} \qquad ( 4 )$$

It is evident that when the charge density of metal complex anion in aqueous phase is small, where (ΔE_{hy})_{A-W} is small and (ΔE_{w-w})_{A-W} is large, metal complex anions have a high probability of transferring to the organic phase. Vice versa, when the charge density of anion in organic phase is big, where (ΔE_{hy})_{A-O} is large and (ΔE_{w-w})_{A-O} is small, the tendency for anions transfer to aqueous phase is enhanced. However, the contribution of the ion association energy depends on the volume of anions when specific interaction can be neglected. A smaller sized metal complex anion and larger sized anion in organic phase tend to improve anion exchange. In most cases, the contribution from hydration energy is generally higher than those from cavitation and solvation energies, when any specific interaction is neglected.

The phenomena observed in this study can be well explained by anion exchange extraction. As there are not enough data in the literature to obtain the actual value of charge density, the estimated value is calculated using charge of an ion divided by the number of atoms forming the ion. The charge density of anions of Cl⁻, PF₆⁻ and NTf₂⁻ is thus calculated and the corresponding values are 1, 0.143 and 0.067, respectively. Precious metals Pt and Pd, in HCl solution present in the form of chloride complex as PtCl₆⁻ and PdCl₄²⁻. The corresponding charge density is 0.286 and 0.4, respectively. Therefore, the extraction percentage decreased in the order of PtCl₆⁻ >PdCl₄²⁻ for metal chloride complex and in the order of Cl⁻>PF₆⁻>>NTf₂⁻ for anion in RTIL phase as shown in FIGS. 1 to 4. With same anion of TFSI, it was observed that distribution ratio increased when increasing the number of CH₂ unit in the cations. It is expected that dielectric constant of RTIL would decrease with increase of the number of CH₂ units in the cations, which enhanced ion association energy, resulting in higher distribution ratio. However, the RTIL of N8,8,8,1 NTf₂⁻ did not follow the trend on anion influence. It might be attributed to the specific interactions between N8,8,8,1 cation and metal complex anion, which increased significantly the extraction percentage. Without specific interaction, the centre atoms of cations of RTILs would not show much influence on ion association energy, which is purely Coulombic attraction, and so did on extraction percentage and distribution ratio. Based on the extraction mechanism described above, metal complex anions present in the same form in both phases and protons do not take part in transfer process. Therefore, solution acidity does not affect extraction percentage. It was observed, however, the extraction percentage of AuCl₄⁻, PtCl₆⁻ and PdCl₄²⁻ decreased with increase of HCl concentration as shown in FIGS. 1 to 4. It has been confirmed that the dielectric constant of aqueous phase decreases with increase of salt concentration, which enhanced ion association energy of metal complex anion with cations in aqueous phase, a lower extraction percentage was thus observed.

The charge density of bare base metal ions, Mⁿ⁺, is n, indicating that bare metal ions have high hydration energy and tend to stay in aqueous phase. In order to lower charge density, complexation needs occur to reduce charge and enlarge the volume of metal ions. Bare metal ions are highly hydrated in aqueous solution. In order to form complex, ligands need to replace water molecules associated with metal ions. When the charge density is low enough for anion exchange, extraction occurs. Therefore, the process of extraction of base metal ions involves two steps: complexation and transfer. During complexation, it is expected that higher concentration of ligands present in the solution, more metal complex is formed, and thus higher extraction percentage is observed as shown in FIGS. 5 to 7. In the stage of transfer of metal complex ions into organic phase, water molecules surrounding metal complex ions are replaced by organic molecules. This process can be viewed by the colour change during transfer, for examples, Cu²⁺, Co²⁺ and Fe³⁺ showed blue, pink and brown colour in aqueous phase, respectively, all of which presented in the hydrated form of metal complex, but changed to red, blue and yellow in RTIL phase, respectively, which are believed in the anhydrous form of metal complex.

In HCl solution, different metal ions, however, have different affinity to water molecules and chloride ions. According to the Hard Soft Acid Base (HSAB) principle, both water molecule and chloride ion are hard bases, but the former is harder than the latter. For group A metals, group I and II A metals belong to hard acid. When the order of group A metals move from IA to VA, the hardness decreases, vice versa, the softness increases. The well-accepted empirical rule is that ‘hard likes hard and soft likes soft’, indicating group I and II A metals have higher affinity to water molecules, so they are highly hydrated and tend to stay in water. Therefore, even phCl can only extract group I or II A metals to a very low extent. The aluminium ions, Al³⁺, in group IIIA belongs to hard acid because of high charge and small ion radii, so it showed the same trend as group I and II A metals. However, group N and V A metals are less hard, which would show high affinity to chloride ions. Group N and V A metal ions thus interact with chloride ions to form chloride complex, facilitating the anion exchange and high extraction percentage was observed as shown in FIG. 8.

As for group B transition metals, Cr³⁺ and Mn²⁺ belong to hard acids, while Zn²⁺ and Cu²⁺ are borderline acids. The hardness follows the order of Cr³⁺>Mn²⁺>Zn²⁺≅Cu²⁺, resulting in the order of extraction percentage as Cr³⁺<Mn²⁺<Zn²⁺≅Cu²⁺. However, HSAB principle cannot explain the extraction behaviour of group HIV B metals. Fe³⁺ is a hard acid, while Co²⁺ and Ni²⁺ are borderline acids. The order of hardness is Fe³⁺>Co²⁺>Ni²⁺, so is the extraction percentage. This phenomenon might be attributed to the different tendency of metal′ions to form a chloride complex, which plays a vital role in the anion exchange extraction. From the UV spectra of metal ions presented in different HCl concentrations, it was found that FeCl₃ presented in chloride complex form even in neutral water, and CoCl₂ existed in hydrated form in neutral water and changed to chloride complex in high HCl concentrations, while NiCl₂ only presented in hydrated form in all HCl concentrations. Therefore, Fe³⁺ can be extracted efficiently in all HCl concentrations, Co²⁺ can be extracted well in high HCl concentrations, but Ni²⁺ cannot be extracted in all HCl concentrations as seen in FIG. 8.

For conventional organic solvent/water systems, when hydrophobic SiO₂ nanoparticles are present in aqueous solution, SiO₂ nanoparticles tend to transfer to organic solvent/water interface and form particle-stabilized emulsion during mixing. However, this phenomenon was not observed at RTIL/water systems in most cases, which might be attributed to the different interfacial tensions between these two systems. For the latter, SiO₂ nanoparticles cannot attach to the RTIL/water interface and, therefore, particle-stabilized emulsion cannot form. RTILs with longer hydrocarbon chain length tend to form micelle in aqueous phase, a prolonged phase separation time was observed. However, the formation of micelles can be prevented in high salt concentrations and rapid phase separation was achieved.

In summary, we have shown that extractions of metals including Pt, Pd, Mg, Ca, Al, Sn, Bi, Cu, Zn, Cr, Mn, Fe, Co and Ni using pure RTILs can be carried out in HCl solutions. The extraction efficiency increased dramatically for group A metals moving from IIA to VA, while it decreased significantly for group B metals moving from IB to IIVB. The extraction percentage decreased in the order of Fe>Co>>Ni for group IIIVB metals.

The influence of anion on extraction percentage showed in the order of Cl>PF₆>>TFSI. The increase of hydrocarbon chain length can enhance the extraction. Cations did not show much influence on extraction except for ammonium cation. The extraction behaviour of metal ions using RTILs can be well described by anion exchange mechanism. RTILs can be used not only as solvent medium, but also novel effective liquid anion exchange extractants. Phase separation can be completed in a few minutes for RTILs with shorter chain length. RTILs containing long hydrocarbon chain showed slow phase separation, however, it can be improved effectively at high chloride concentrations. It was observed that SiO₂ nanoparticles did not show much influence on Cu extraction. For RTIL/Water system, no particle-stabilized emulsion was observed for copper extraction containing hydrophobic SiO₂ nanoparticles in the solution.

### Example 2

### Extraction of Metals from Mixed Metal Ion Solutions Using RTILs

### RTILs

All RTILs used in this investigation (listed below) were purchased from IoLiTec, Germany, except for tetradecyl(trihexyl)phosphonium bis(trifluoromethanesulfonyl)imide, which was purchased from Strem Chemicals, USA. Five types of cations were studied: imidazolium (Im), piperidinium (Pip), pyrrolidinium (Pyr), ammonium (N) and phosphonium (P). In all cases the anion was bis(trifluoromethanesulfonyl) imide (NTf₂). The anions hexafluorophosphate (PF₆) and chloride (Cl) were further chosen for hmim and phosphonium cations, respectively. Imidazolium and ammonium cations with different chain lengths were also used.
Ethyl-3-methylimidazolium bis(trifluoromethanesulfonyl)imide, 98%, (emim.NTf₂)
1-Hexyl-3-methylimidazolium bis(trifluoromethanesulfonyl)imide, 98%, (hmim.NTf₂)
1-Hexyl-3-methylimidazolium hexafluorophosphate, 99%, (hmim.PF₆)
1-Dodecyl-3-methylimidazoliumbis(trifluoromethylsulfonyl)imide, 98%, (dmim.NTf₂)
1-Methyl-1-propylpiperidinium bis(trifluoromethylsulfonyl)imide, 99%, (mppip.NTf₂)
1-Methyl-1-propylpyrrolidinium bis(trifluoromethylsulfonyl)imide, 99%: mpPyr.NTf₂
Tetradecyl(trihexyl)phosphonium bis(trifluoromethanesulfonyl)imide, 97%, (P_{14,6,6,6}.NTf₂)
Tetradecyl(trihexyl)phosphonium chloride, 96%, (P_{14,6,6,6}.Cl)
Methyltrioctylammonium bis(trifluoromethylsulfonyl)imide, 99%, (N_{8,8,8,1}.NTf₂)
Butyltrimethylammonium bis(trifluoromethylsulfonyl)imide, 99%, (N_{4,1,1,1}.NTf₂)

### Metal Salts

Precious metal salts of AR grade, HAuCl₄.3H₂O PdCl₂, and H₂PtCl₆.×H₂O, were purchased from Sigma-Aldrich.

### Stock Solutions of Au, Pt and Pd Mixtures

All metal salts were dissolved in MilliQ water of different HCl concentrations (typically 0.02, 0.1 and 2 M HCl, respectively). The concentration of Au, Pt and Pd in the mixture was measured using ICP.

### Conventional Batch Solvent Extraction

0.5 ml RTIL and 2 ml aqueous solutions containing metal ions were added into a small glass vial. They were mixed vigorously with a magnetic stirrer for 30 min to achieve equilibrium distribution. When extraction was completed, the solution was left overnight to phase separate. After that, the aqueous phase was carefully removed and used for ICP measurement.

### Microfluidic Solvent Extraction

Glass microfluidic chips (IMT, Japan) containing two microchannels (100 μm×40 μm), that merge temporarily to form a liquid-liquid interface between the flowing aqueous and organic phases, were used for the microfluidic solvent extractions and details of these are shown in FIG. 8. The merged (extraction) channel was 160 μm×40 μm, with a “guide structure” in the middle (a 5 μm high ridge parallel to the direction of flow) to stabilize the two phase concurrent flow. The microfluidic experiments were carried out according to the protocol described in published international patent application 2010/022441 (details of which are incorporated herein by reference), with a variable flow rate to adjust the contact time in each extraction experiment.

Liquids were introduced into the microchip using precision syringe pumps (KD Scientific) with glass syringes (Hamilton, 1 mL and 2.5 mL) that were fitted with PEEK adaptors and tubing (Upchurch Scientific, 150 μm inner diameter). The microchip experiments were monitored optically (Olympus microscope, BH2-UMA, with a Moticam 2000 digital camera). Different flow rates (up to ˜10 ml/h) and two different liquid-liquid contact lengths, L (80 or 240 mm) were used to access a wide range of extraction times (Priest, Zhou et al. 2011).

### Extraction Percentage, Distribution Ratio and Separation Factor

Extraction percentage is defined as the amount of solute in the ionic liquid phase (after extraction) divided by the amount in aqueous phase (before extraction). ICP techniques were used to determine the concentration of metal ions in the aqueous solutions before and after extraction. The extraction percentage was calculated as:

E %=[(C₀−C*)/C₀]×100
C₀: concentration before extraction, C*: concentration after extraction.

Distribution ratio (DR) is defined as the concentration of solute in the ionic liquid phase divided by its concentration in aqueous phase after extraction. It was calculated as:

DR=[M]_{IL}/[M]_{Aq}.
[M]_{IL} and [M]_{Aq}: concentration in ionic liquid phase or aqueous phase after extraction.

Separation factor (SF) of A to B from A and B mixed solution is calculated as:

SF=DR_{A}/DR_{B}
DR_{A}: distribution ratio of A, DR_{B}: distribution ratio of B.

### Results—Conventional Batch Extraction

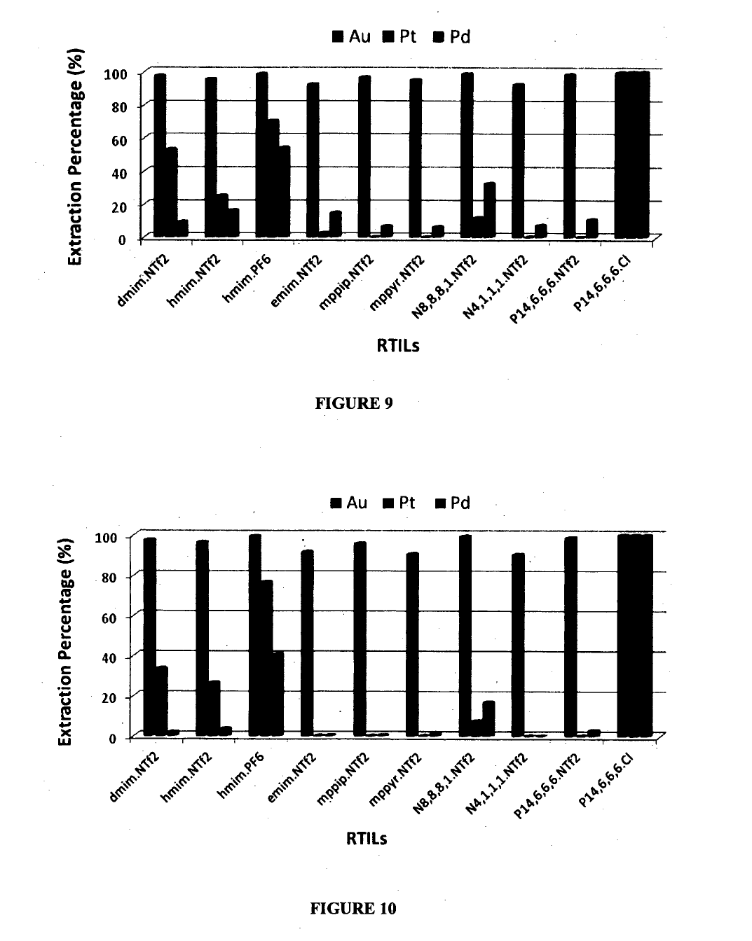

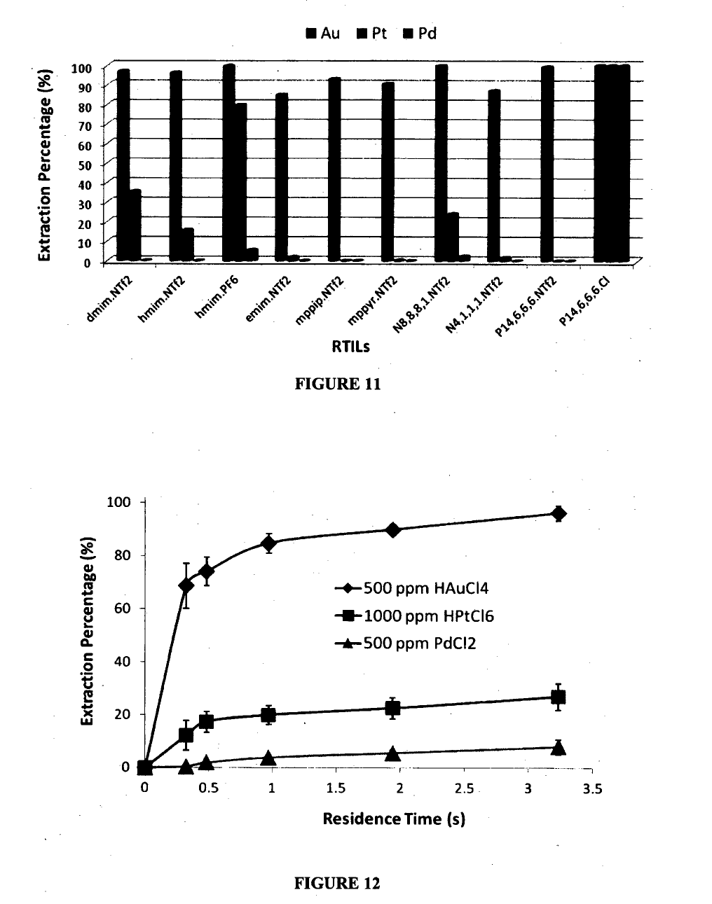

The selective extraction of Au versus Pt and Pd from HCl solutions using pure RTILs was carried out in conventional batch solvent extraction. The influence of different ionic liquids on the extraction of Au, Pt and Pd from Au, Pt and Pd mixtures dissolved in 0.02, 0.1 and 2 M HCl solutions is shown in FIGS. 9-11, respectively. The same extraction performance of Au, Pt and Pd from their mixtures using RTILs was observed when compared with that from single metal solutions. The extractability of precious metals decreases in the order of Au>Pt>Pd from HCl solutions. The influence of anions of RTILs on extraction efficiency is dominant. For all the metals, the extraction efficiency of RTILs decreases in the following order: Cl⁻>PF₆⁻>NTf₂⁻, regardless of what cations the RTILs have. Longer hydrocarbon chains in the cation of the RTIL give rise to a higher extraction percentage. With chains shorter than six CH₂ units, low extraction percentages were found. With an increase in HCl concentration, the extraction percentage decreases in most cases.

The distribution ratio describes how well a substance can be extracted, while the separation factor describes how well two substances can be separated from their mixture. The distribution ratios of Au, Pt and Pd in 2 M HCl concentration, as well as the separation factors of Au/Pt, Au/Pd and Pt/Pd are listed in Table 1. It can be seen that Au can be extracted very well by all RTILs selected with extraction percentages above 90% in most cases. Except for P_{14,6,6,6}.Cl, which can extract effectively all metals, hmim.PF₆ can extract Pt and Pd to a moderate extent. For all other RTILs selected, Pt and Pd cannot be extracted efficiently. Good selectivity for Au extraction can be found using RTILs including emim.NTf2, mppip.NTf2, mppyr.NTf2, N4,1,1,1.NTf2 and P14,6,6,6.NTf2. It was found that above 85% of gold was extracted using the five RTILs mentioned above, while less than 5% of Pt and Pd were extracted. To separate Pt from Pd, dmim.NTf2, hmim.NTf2 and hmim.PF₆ are effective from 2 M HCl solution. Continuous separation of Au, Pt and Pd from their mixture can be achieved by first choosing one of the RTILs such as emim.NTf2, mppip.NTf2, mppyr.NTf2, N4,1,1,1.NTf2 and P14,6,6,6.NTf2 to extract Au, then using hmim.PF₆ to extract Pt, whilst Pd will be left in the feed solution.

TABLE 1
The distribution ratios and separation factors of Au, Pt and Pd in 2M HCl

| | Distribution Ratio | | | Separation Factor | | |
|---|---|---|---|---|---|---|
| RTILs | Au | Pt | Pd | Au/Pt | Au/Pd | Pt/Pd |
| dmim.NTf2 | 101.3 | 1.8 | 0.07 | 56.6 | 1460 | 25.7 |
| hmim.NTf2 | 71.7 | 0.6 | 0.002 | 122.2 | 34889.7 | 300 |
| hmim.PF6 | 718.9 | 12.3 | 0.3 | 58.6 | 2747.4 | 41 |
| emim.NTf2 | 14.8 | 0.08 | 0.02 | 176 | 865.3 | 4 |
| mppip.NTf2 | 49.3 | 0.03 | 0.01 | 1413.4 | 5011.7 | 3 |
| mppyr.NTf2 | 25.9 | 0.04 | 0.005 | 589.4 | 5213.8 | 8 |
| N8,8,8,1.NTf2 | 952.7 | 0.9 | 0.1 | 1043.9 | 6917.4 | 9 |
| N4,1,1,1.NTf2 | 23.2 | 0.09 | 0.05 | 247.8 | 442.7 | 1.8 |
| P14,6,6,6.NTf2 | 377.7 | 0.0003 | 0.03 | 1143311 | 13928.8 | 0.01 |
| P14,6,6,6.Cl | 32503.8 | 6731.5 | 32621.9 | 4.8 | 1 | 0.2 |

### Results—Microfluidic Extraction

The extraction of Au, Pt and Pd from their mixtures at 0.1 M HCl solution was carried out in a microchannel. ICP was used to measure the concentration of metals in the solution before and after extraction. The extraction percentage of Au, Pt and Pd as a function of residence time using hmimNTf₂ is shown in FIG. 12. The extraction percentage of all metals increased with an increase in residence time. Au can be extracted above 85%, while Pt and Pd can be extracted around 20% and 5% in several seconds. The extraction percentages of Au; Pt and Pd in the microchannel are compatible with those in bulk extraction, shown in FIG. 9, which indicates that the extraction using RTILs proceeds very fast and reaches the maximum (indicated by a plateau) within seconds.

In summary, the extraction of precious metals including Pt and Pd from their mixtures in HCl solutions using pure RTILs was carried out in both bulk and microchannels. The influence of anion on extraction percentage showed in the order of Cl>PF₆>>TFSI. The increase of hydrocarbon chain length can enhance the extraction. Highly selective extraction and continuous separation of Au, Pt and Pd can be achieved by choosing suitable RTILs and adjusting the HCl concentration.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

### REFERENCES

Al-bazi, S. J. and A. Chow (1984). “Platium group metals-solution chemistry and separation methods (ion exchange and solvent extraction).” Talata 31 (10 A): 815.
Bernardis, F. L., R. A. Grant, et al. (2005). “A review of methods of separation of the platinum-group metals through their chloro-complexes.” React. Funct. Polym. 65(3): 205-217.
Billard, I., A. Ouadi, et al. “Liquid-liquid extraction of actinides, lanthanides, and fission products by use of ionic liquids: from discovery to understanding.” Anal. Bioanal. Chem. 400(6): 1555-1566.
Bond, A. H., M. L. Dietz, et al., Eds. (1999). Progress in metal ion separation and preconcentration: an overview. In Metal Ion Separation and Preconcentration: Progress and Opportunities. Washington, D.C., 2-12, American Chemical Society.
Dai, S., et al., (1999). “Solvent extraction of strontium nitrate by a crown ether using room-temperature ionic liquids.” J. Chem. Soc., Dalton Trans.: 1201-1202.
Dietz, M. L. (2006). “Ionic liquids as extraction solvents: where do we stand?” Separation Science and Technology: 2047-2063.
Gmehling, J. (2004). “Ionic liquids in separation processes.” Chem. Thermodyn. Ind.: 76-87.
Huddleston, J. G., H. D. Wilauer, et al. (1998). “Room temperature ionic liquids as novel media for ‘clean’ liquid-liquid extraction.” Chem. Commun.: 1765-1766.
Kumar, V., S. K. Sahu, et al. (2010). “Prospects for solvent extraction processes in the Indian context for the recovery of base metals. A review.” Hydrometallurgy 103(1-4): 45-53.
Mooiman, M. B. (1993). The solvent extraction of precious metals—a review: precious metals. 17th IPMI, pp 411, USA.
Morrison, G. H. and H. Freiser (1957). Solvent extraction in analytical chemistry. New York, Wiley.
Priest, C., J. Zhou, et al. (2011). “Microfluidic extraction of copper from particle-laden solutions.” Int. J. Miner. Process. 98(3-4): 168-173.
Visser, A. E. and Rogers R. D. (2003). “Room temperature ionic liquids: new solvents for the f-element separations and associated solution chemistry.” Journal of Solid State Chemistry: 109-113.
Yu, J. M. (2004). Solvent extraction chemistry of precious metals. Beijing, Chemical Industry press.
Zhang, W. L. (1984). “Extractants and systems used for extraction and separation of precious metals.” Precious Metals 5(3): 37-43.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

1. A process for extracting a target metal ion from an aqueous feedstock containing, inter alia, the target metal ion, the process comprising:
providing said feedstock;
contacting the feedstock with a room temperature ionic liquid (RTIL) comprising a cationic component and an anionic component under liquid-liquid extraction conditions for a time sufficient to allow transfer of at least some of the target metal ion from the feedstock to the RTIL;
separating the RTIL from the feedstock;
recovering the target metal ions from the RTIL,
wherein the RTIL and the aqueous feedstock is substantially free of an extraneous organic extractant.

2. (canceled)

3. The process according to claim 1, wherein the process also comprises treating the aqueous feedstock with a material comprising inorganic anions prior to contact with the RTIL.

4. The process according to claim 3, wherein the inorganic anions comprise a halide ion selected from iodide, bromide, chloride, and fluoride.

5. (canceled)

6. (canceled)

7. (canceled)

8. The process according to claim 4, wherein the halide ion comprises chloride and the process comprises treating the aqueous feedstock with HCl to increase the chloride concentration in the aqueous feedstock prior to contact with the RTIL.

9. The process according to claim 8, wherein the aqueous feedstock is treated with 0.02M HCl, 0.1M HCl, 2M HCl, 3M HCl or 7M HCl.

10. (canceled)

11. (canceled)

12. (canceled)

13. (canceled)

14. The process according to claim 4, wherein the halide comprises chloride and the process comprises treating the aqueous feedstock with KCl to increase the chloride concentration in the aqueous feedstock prior to contact with the RTIL.

15. The process according to claim 14, wherein the aqueous feedstock is treated with 3M Kcl.

16. The process according to claim 1, wherein the cationic component of the RTIL is selected from the group consisting of: imidazolium, piperidinium, pyrrolidiunium, ammonium and a phosphonium.

17. (canceled)

18. (canceled)

19. (canceled)

20. (canceled)

21. The process according to claim 16, wherein the cationic component of the RTIL comprises at least one alkyl group comprising six or more carbon atoms.

22. The process according to claim 21, wherein the anionic component of the RTIL is selected from the group consisting of: bis(trifluoromethanesulfonyl)imide, chloride and hexafluorophosphate.

23. (canceled)

24. (canceled)

25. The process according to claim 1, wherein the RTIL is tetradecyl(trihexyl)phosphonium chloride (P_{14,6,6,6}.Cl) and the target metal ion is selected from the group consisting of: Pt, Pd, Cu, Fe, Co, Mn, Zn, Bi, and Sn.

26. (canceled)

27. The process according to claim 1, wherein the RTIL is 1-hexyl-3-methylimidazolium bis(trifluoromethanesulfonyl)imide (hmim.NTf₂) and the target metal ion is selected from the group consisting of: Pt, Bi, and Sn.

28. (canceled)

29. The process according to claim 1, wherein the RTIL is 1-dodecyl-3-methylimidazolium bis(trifluoromethanesulfonyl)imide (dmim.NTf₂) and the target metal ion is Pt.

30. (canceled)

31. The process according to claim 1, wherein the RTIL is methyltrioctylammonium bis(trifluoromethylsulfonyl)imide (N_{8,8,8,1}.NTf₂) and the target metal is selected from the group consisting of: Pt, Pd, Bi, and Sn.

32. (canceled)

33. The process according to claim 1, wherein the RTIL is 1-hexyl-3-methylimidazolium hexafluorophosphate (hmim.PF₆) and the target metal ion is selected from the group consisting of: Pt and Pd.

34. (canceled)

35. The process according to claim 25 wherein the target metal ion comprises Sn, Bi, Cu, Zn, Mn, Fe and/or Co ions and the target metal ion is selectively extracted from the aqueous feedstock relative to Mg, Ca, Al, Cr, and/or Ni ions also present in the aqueous feedstock.

36. A process for selectively extracting Sn, Bi, and/or Fe ions from an aqueous feedstock that also contains Mg, Ca, Al, Cu, Zn, Cr, Mn, Co, and/or Ni ions, the process comprising:
providing said feedstock;
treating the feedstock with hydrochloric acid to a concentration of about 3M HCl; contacting the feedstock with 1-hexyl-3-methylimidazolium hexafluorophosphate or methyltrioctylammonium bis(trifluoromethylsulfonyl)imide under liquid-liquid extraction conditions for a time sufficient to allow transfer of at least some of any Sn, Bi, and/or Fe ions from the feedstock to the 1-hexyl-3-methylimidazolium hexafluorophosphate or the methyltrioctylammonium bis(trifluoromethylsulfonyl)imide; and
separating the 1-hexyl-3-methylimidazolium hexafluorophosphate or the methyltrioctylammonium bis(trifluoromethylsulfonyl)imide from the aqueous feedstock, wherein the 1-hexyl-3-methylimidazolium hexafluorophosphate or the methyltrioctylammonium bis(trifluoromethylsulfonyl)imide and the aqueous feedstock are substantially free of an extraneous organic extractant.

37. (canceled)

38. The process according to claim 1, wherein the process is carried out in a microfluidic extraction device.
